(19) United States
(12) Patent Application Publication
(10) Pub. No.: US 2013/0037986 A1
(43) Pub. Date: Feb. 14, 2013

(54) METHOD, SYSTEM AND RESIN SHEET FOR PRODUCING FIBER-REINFORCED MOLDED PARTS IN A MOLDING PRESS

(71) Applicant: Matthias Graf, Bretten (DE)

(72) Inventor: Matthias Graf, Bretten (DE)

(73) Assignee: Dieffenbacher GmbH Maschinen-und Anlagenbau

(21) Appl. No.: 13/582,602

(22) PCT Filed: Mar. 13, 2011
(86) PCT No.: PCT/EP2011/001234

§ 371 Date: Oct. 1, 2012

(30) Foreign Application Priority Data
Mar. 13, 2010 (DE) 10 2010 002 844.4

(51) Int. Cl. B29C 47/14; B32B 3/26

(52) U.S. Cl. 264/177.17; 425/115; 428/156

(57) ABSTRACT

Method, system and resin sheet for producing fiber-reinforced molded parts (SMC) by extrusion in a molding press from a fiber-reinforced resin sheet which is continuously produced in a flat web installation. At least one resin base layer is combined with fibers in a mixing device, is subsequently mixed in a fulling and saturating device, and is finally matured in a thickening device to form a continuous resin sheet, wherein the continuous resin sheet is cut to form cut sheets and is then transferred, either directly or joined in a structure with other cut sheets, by a transfer device to a tool of a molding press in which it is then pressed to form a fiber-reinforced molded part. Reinforcements are applied on at least one resin base layer for forming a reinforcement zone which is delimited in length and/or width relative to at least one resin base layer before joining the resin base layers.

The invention relates to a method for producing fiber-reinforced molded parts (SMC: sheet-molded compound) in a molding press according to the preamble of patent claim 1 and also a facility for producing fiber-reinforced molded parts (SMC) according to the preamble of patent claim 10. Furthermore, the invention relates to a resin mat for use in a molding press according to claim 17.

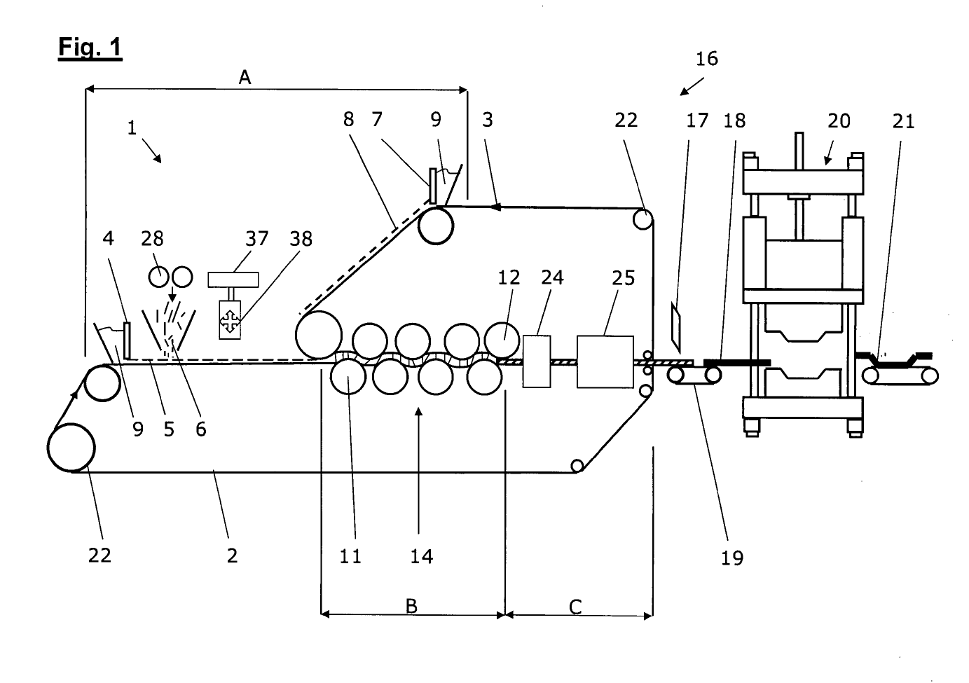

Because of their good mechanical properties and the favorable price, such molded parts produced according to the SMC method are the most used duroplastic fiber composite plastics. Up to this point, to produce SMC parts, firstly the raw material is produced, consisting of a resin compound (resin formulation) having intercalated cut glass fibers. This resin formulation is laid on thin transparent plastic films (carrier films) and subjected to a maturing process. The current maturing process lasts 4-5 days and is used for thickening the resin formulation with the mixed-in fillers and/or for improved impregnation of the glass fibers. The resin formulation consists of resins, thermoplastic solutions, fillers, flow improvers, integrated parting agents, inhibitors, and maturing agents. It is stirred at predefined temperature to form a well dispersed liquid and is also provided with a thickening agent, in powdered or liquid form, on the resin mat facility and squeegeed via squeegee blades onto the lower and upper carrier films and adjusted in width. The cut glass, for example, from endless rovings using cutting mechanisms, is metered onto the resin formulation layer of the lower carrier film. The upper carrier film having the resin formulation is then laid on the cut fiber coating. Through a subsequent milling process, the fibers are mixed/impregnated with the resin formulation and subsequently wound onto a roll as a resin mat or temporarily stored as a planar semifinished product for the maturing process. Through the maturing process, the resin formulation thickens so strongly that the carrier films can be drawn off without residue. Tailored mats, which are tailored to the respective molded part to be produced, are cut out of the flat semifinished product or the rolls and laid singly or as a packet in a molding press and compressed (FIG. 1). This known SMC method has been supplemented in the meantime by an optimized method. This D-SMC method no longer requires a maturing time or the maturing time is shortened by adaptation of the resin used or by the additives, respectively, in such a manner that after the discharge from a flat belt facility as the production device for the SMC semifinished product, the SMC final product can be produced directly in a molding press. A lengthy or multi-day waiting time for the maturing is omitted.

A method and a facility are known from EP 1 386 721 A1, which were based on the problem of providing the resin mats (SMC semifinished product) with the suitable plasticity for an immediately following direct processing to form molded parts. Particularly preferably, films are to be able to be dispensed with and the control of the maturing time or the thickening time of the resin mats was substantially carried out by the introduction of heat in a temperature-controlled thickening instantaneous heater. In the meantime, the continuous direct method for producing fiber-reinforced molded parts without intermediate storage of the resin mats for the ensuring process has been implemented in industrial life and has significant advantages in the field of just-in-time production, substantial problems of storage and in particular just-in-time delivery being able to be avoided. It is particularly to be emphasized that the most compact possible facility has been disclosed in EP 1 386 721 A1, in which the temperature-controllable belt carriers were arranged meandering in a housing in a thickening instantaneous heater for a chronologically predefined maturing process, depending on the required length. Through the arrangement of the belt carriers and their embodiment in length and number one over another, the maturing process can be designed having appropriate maturing time.

This facility has fundamentally proven itself, but has a lack of flexibility in highly industrialized operation. In particular, it is disadvantageous that in the event of even slight deviations of the wall thickness in a workpiece to be molded, SMC mats or SMC mat laid fabrics adapted thereto must be introduced into a molding press. A resin mat is typically cut up for this purpose or a laid fabric is prepared using a pattern from parts and/or multiple uniform resin mats, which is assembled manually or automatically by means of industrial robots and laid in its entirety into the tool. Such mat laid fabrics must always be conceived for the specific case and the robot controller or the facility controller, respectively, must be re-taught upon every tool change. This costs programming time and also significantly increases the maintenance expenditure. Furthermore, unused facility technology is present in the case of the production of simple components, if no or only very simple mat laid fabrics must be assembled. Another aspect is that the normally homogeneous and uniform SMC resin mats must regularly be adapted to the workpieces to be molded, for example, by rolling out, drawing, stretching, or cutting open.

In particular for special molded parts which will have a location of extreme bending strain or a planned opening, laid fabrics are currently prepared manually or automatically from specially cut resin mats, which take the special requirements of the molded part into consideration. A required opening is typically used in molded parts for mounting further molded parts. A fuel tank connecting piece in a fender or openings for auxiliary headlights, turn signals, and towing lugs in a bumper could be mentioned as examples. These openings have the task in common of receiving further machine elements or exposing a opening and are therefore partially subjected to a regular strain in the usage area (wind, folding mechanisms, . . . ). The previous manual or partially-automatic add-ons of these reinforcements directly in a tool or in a laid fabric prevent automated manufacturing and are extremely imprecise and inflexible in the event of production changeovers. Undesired layering of material also results in particular in the add-on regions, which in turn places the later integrity of the molded part in question.

The problem of the invention is to provide a facility and a method for operating a facility for producing fiber-reinforced resin mats for the direct production of SMC molded parts, which have a substantially greater leeway and a simplified facility technology with respect to the possible production quantity per unit of time and/or production types in relation to the demand with respect to the prior art. In particular, the object is to be achieved that resin mats can be produced for SMC production in molding presses, which at least partially already have geometries corresponding to the tool of the molding press to be used after exiting from the flat belt facility and/or have additional reinforcements (reinforcement regions) at regions provided for this purpose, which improve the respective molded part in its application or durability.

In an expansion of the problem, not only uniform SMC mats having a predefined volume or a predefined width or height, respectively, are to be able to be produced, but rather with respect to a workpiece to be produced in a molding press, an appropriately adapted and appropriately shaped SMC mat is prepared, which can either be directly compressed without additional effort and/or significantly simplifies the production of a laid fabric from tailored mats or reduces the number of the required tailored mats of a laid fabric.

The solution to the problem for the method is that to prepare a reinforcement region, which is delimited in length and/or in width in relation to at least one resin formulation layer, means for reinforcement are applied to at least one resin formulation layer before the resin formulation layers are joined.

The solution to the problem for a facility is that, in the production direction before the joining region of two resin formulation layers to form a resin mat, to prepare at least one reinforcement region, at least one application device is arranged for depositing means for reinforcement and/or at least one squeegee blade, which is adjustable over the width, is arranged to prepare means for reinforcement on a resin formulation layer.

The solution for a resin mat is that the resin mat produced in a flat belt facility has, in its height h and/or over its width, a differentiated contour and/or at least one reinforcement region consisting of means for reinforcement. In an expansion of the solution, the resin mat is adapted in at least one contour and/or at least one reinforcement region to a tool or at least a part of a tool in a molding press.

Special reinforcement regions in the interior of an SMC resin mat can now advantageously be produced in an automated and simplified manner according to the method according to the invention and a proposed facility. By means of a suitable application device, for example, an industrial robot and/or an outlet die for resin formulation and/or a traversing scattering device for fibers, the reinforcement regions are unwound or laid in a targeted manner so that they are arranged in a contour mat section and later in the corresponding tailored mat precisely fitted to the corresponding tool in a molding press or the molded part to be produced, respectively.

Topographic patterns can thus be formed on a resin formulation, for example, by means of a film applicator for the resin formulation or by means of a local scattering device and/or by means of suitable devices which form the already finished reinforcement regions beforehand and place them on the resin formulation layer in accordance with the specifications. Other fibers, longer fibers, woven fiber inlays, oriented fiber agglomerations, or the like can be used in this case.

The following statements are to apply with respect to the concepts used: The invention understands a resin mat having a variable contour as a resin mat which, after being tailored to form a tailored mat of a predefined length, has a differentiable difference in its width b and/or in its height h or is adapted to the supply of one or more molding presses or their tools, respectively. With respect to the fibers, the invention understands the varied quantity introduction in such a manner that a different quantity of fibers is provided in the resin mat or in a tailored mat, respectively, over the length and/or the width. This results through a change of the scattering quantity over the width in the case of a (transport) belt continuously progressing underneath. The scattering of the fibers is preferably also adapted over the width to the set width of the resin formulation discharge, so as not to contaminate the transport belts unnecessarily and/or to minimize the material losses.

It is advantageously now possible using the facility for the method according to the invention to produce resin mats adapted to the tool in one or more molding presses for direct use,
multiple form presses can be supplied with different SMC mats, which are adapted to the existing, in particular differing tools,
industrial robots are primarily used not for preparing mat laid fabrics, but rather preferably only for the transfer between flat belt facility and molding press,
greatly varying tools (with respect to volume and/or time) can be used in one or more molding presses, or
extremely highly reactive resin formulations can be used, which have a very small time window for the compression.

It is presumed that the supply with resin formulation for squeegeeing onto films or conveyor belts is fundamentally ensured and it can be delivered either in an appropriate quantity or can be produced on location using suitable production devices.

The above-mentioned advantages are particularly decisive if multiple molding presses are arranged as a whole in a production facility for SMC components. In particular, it is preferable for a complete and automated controller of the overall facility made of at least one resin mat production and at least one, preferably multiple molding presses having transfer devices interposed between these two main elements to be arranged. The variant is preferably provided in which one flat belt facility operates multiple molding presses. The molding presses can operate different tools, which are charged depending on the pressing time expenditure. For example, one press having a three-minute pressing time can be charged twice with the resin mat contours assigned thereto in the case of a parallel press to be charged having a six-minute pressing time, before one resin mat contour is prepared for the second press.

According to the method, the individual facility parts are interconnected and controlled in such a manner that production interruptions or maintenance work in the molding presses can be automatically controlled so that the transfer device and/or the responsible facility part for production of the resin mats ensure the provision of the resin mats to the molding presses in an optimized manner, as a function of the required demand.

It is in the nature of the molding press or its tools, respectively, that a minimum cleaning of the tool is provided for all above-described compressions. Furthermore, there are maintenance intervals, which also occur at regular intervals but only last a few minutes. The control device controls the resin mat production in the flat belt facility in such a manner that depending on the demand for resin mats to be expected, the required number of contour-adaptive resin mats can always be transferred by the press controllers. Simultaneously, the control device prevents an overproduction of resin mats which cannot be processed from occurring because of the maintenance or cleaning intervals.

Furthermore, the production facility can optimally react to production changeovers/changes, and does not have to manage only with the variation of the belt speed and the discharge volume with uniform resin mats. Alternatively, in this context, at least one additional parameter can be changed, in particular the heat introduction into the resin mat during the maturing. A microwave arrangement is particularly preferably used in this context, which can introduce the heat introduced into the resin mat independently of the storing or guiding belts, respectively, of the flat belt facility. Heat transfer by convection is entirely in the scope of what is feasible and typical, but high-quality belts for the transport of the resin mats, in particular if no films are used, typically have good insulating properties. In a particularly advantageous manner, the heater, preferably an HF or a microwave heater, is connected by means of a time and/or distance controller to the resin mat production device (flat belt facility), so that the heat introduction can react precisely to the different volumes (differentiated heights and widths) of a resin mat section. Partial overheating or insufficient heat introduction are to be avoided very urgently. It is also conceivable that one part of the thickening line is rigid and a second part of the thickening line is variable in length, so that in particular in large facilities, the thickening line consists of two devices when physically considered, a thickening line or thickening device, respectively, which is rigid and/or variable in length.

With respect to the transfer device, it is to be noted that it can substantially consist of multiple function-providing facility parts, which cannot be implemented or presented further, since not all possible variants of facility types or variations can be claimed. However, the transfer device comprises, as defined in the invention, the region from the exit point of the resin mat out of the region of the resin mat production. This exit point is preferably identical with the expiration of the main maturing time of the resin mat. However, it is in the nature of the resin mats that this point in time is a function of many factors. Rather, there is a main maturing time window here, which is defined from the point in time “earliest possible processing” and “latest processing”. The times lying outside the main maturing time window result in either unmatured or overmatured resin mats, which substantially cannot be compressed or can no longer be compressed. With respect to the latest processing, of course, time must also be calculated in for the transfer device or until the introduction into the molding press, respectively. A transfer device preferably consists of a cutting device, a possibly required device for drawing off the optional films from the resin mats, and optional device for assembling a resin mat laid fabric of one or more resin mats, an optional device for the transport of the resin mats/resin mat laid fabric to one or more molding presses, and a corresponding transfer device for transferring the resin mats/resin mat laid fabric into a molding press.

As an advantage and result of all method steps and features of the facility according to the invention, fiber-reinforced tailored mats, the mentioned fibers preferably being cut glass made of rovings and/or long fibers or short fibers for improving the stiffness of the SMC molded part, can be supplied with the correct plasticity into an SMC direct method of further processing to form fiber-reinforced duroplastic molded parts, i.e., the SMC direct method according to the invention is capable of providing extremely reproducible long-fiber-reinforced duroplastic materials to the processor, which are also adapted precisely to the contour of the tool of a molding press. For this purpose, the resin mats are produced with sectionally diverging volumes of resin formulation and/or fibers, during the production in the mixing device, different production volumes per unit of time being set by means of a control device. To set the production volume per unit of time, the discharge height and/or the discharge width of the resin formulation and/or the discharge quantity of the fibers can be changed. The endless resin mat is preferably divided into contour mat sections, which substantially correspond in their length to the tailored mats. For this purpose, the change of the resin mat is carried out sectionally or per unit of time. However, it is also conceivable that for strong contour indentations or changes, the (transport) belt for the resin formulation is briefly stopped, in order to give the positioning devices the opportunity of setting the changed width or height of the resin formulation. Furthermore, it is conceivable that the contour is not changed uniformly over the width, but rather that differentiated contours are also possible over the width during the preparation within a resin formulation. In this case, the squeegee blade is set divided over the width and differentiated in its height setting, for example, by a main squeegee blade for a fundamental resin formulation layer height and assigned squeegee blade slides, preferably multiple squeegee blade slides arranged over the width, which hold back or release the resin formulation in a targeted manner. Tracks in the production direction having different heights result. Such a continuous or distinct increase can alternatively also be formed by an additional applicator (wide slot die) after a squeegeeing of a resin formulation layer onto a belt or a film.

The variable contour is preferably adapted in height h and/or width b and/or the quantity of fibers of the resin mat, in accordance with the requirements of the molded parts to be produced in the molding press. It is particularly advantageous if the resin mat is heated by means of at least one heating device between the milling and impregnation device and the tailoring device. The heat energy to be introduced into the resin mat is to be adapted by the heating device to the different contours of the resin mat. A microwave or high-frequency heater suggests itself as the heating device. To set the contours, the control device can activate at least one positioning device for setting the width b by at least one movable side wall of a squeegee blade and/or the control device can activate at least one positioning device for setting the height h by at least one movable squeegee blade and/or the control device can activate the fiber supply device for setting the quantity of fibers. For complex workpieces, multiple successive contour mat sections of identical or different contours can be assembled to form a laid fabric and compressed in a tool of a molding press to form a molded part.

The cut glass/the fibers are normally always to be covered on both sides with resin filler mixture, since otherwise partially dry fibers would arise in a sticky manner on the resin mat in the production method. In the event of a differentiated layer structure, a multilayer structure of the resin formulation layers is therefore to be used. Here, for example, the lower resin layer is covered with fibers in the same contour and with a cover layer made of resin formulation (layer) having the same contour. These two resin layers are generated congruently and correspondingly time-controlled via the two squeegee blades. An additional intermediate layer having deviating (differentiated) layer can also be produced via a cutting mechanism movable in the directions b/s (x/y) and a resin discharge head (for example, having a slot die) movable in the b/s (x/y) directions. In order to obtain the correct structure, firstly the resin of the second contour is to be applied to the fiber layer of the first contour. The application of the fibers on the second contour is then performed, and finally the resin layer of the first contour is applied over the upper film. Typically, where less resin filler mixture (HFG) is squeegeed on, proportionally less cut fibers can also be applied, in order to maintain the same mixing ratio or also optionally to intentionally deviate therefrom. Hollow glass beads for reducing the component weight can either be incorporated in the HFG already in the extruder or, however, can also be scattered onto the resin layer or into the fiber layer. Fundamentally, the individual contour sections can also be divided longitudinally at least once in the production direction (for example, with a center cut). The longitudinal cut can also follow a contour, the outer contours on the left and right not necessarily having to be identical. For example, two different tools of two or one molding presses can be charged with a resin mat contour of equal length, the right contour (of the longitudinal side) not having to be identical to the left contour (longitudinal side).

The targeted introduction of reinforcement regions into molded parts, preferably at locations of excess or extreme bending strains or, for example, at planned openings in the molded parts, can therefore be caused easily. The simple possibility now results of using a higher fiber proportion for higher stiffness precisely at these regions, so that edge fractures are substantially precluded. The counterpart, an increase of the mixing in the direction of the resin formulation, would also be conceivable, so that the molded part can react more flexibly in specific regions to bending strains. For this purpose, additional resin formulation could be introduced in or on an already provided resin formulation. A person skilled in the art understands that the resin formulation mentioned here also includes a resin filler mixture, in which fillers such as chalk or hollow glass beads have been introduced into the resin formulation. A conceivable application device for a reinforcement zone to be applied after a squeegee blade or a reinforcement region which is not limited to discontinuous and delimited reinforcement regions, but rather also comprises continuous linear reinforcement regions, would be a discharge die in slot or round form having a corresponding associated conveyor pump. An extruder having discharge die, an application roller optionally having a skimmer, or similar devices would also be possible. With respect to the fiber introduction, in addition to the mentioned short or long fibers, an endless fiber or a fiber belt, fiber woven parts, fiber nonwoven material, or fiber laid fabrics can also be used, which can be constructed in one or even multiple layers. The inlays which promote strength are preferably pre-impregnated, thus, for example, in the case of fibers they already have the most uniform possible coating with resin formulation. Examples of this would be endless fibers which pass through an impregnation station before a chopping device or also are applied in endless form to a resin formulation layer directly after the impregnation. Unidirectional, preferably impregnated fiber belts (fiber tapes), fiber woven pieces, fiber laid fabrics, fiber nonwoven material, or the like, are also usable.

The transfer point for cut fibers to a resin formulation layer would preferably be a cutting head having a point-shaped or linear discharge device, which can apply local reinforcements through an x/y linear drive at arbitrary points of the SMC mat and thus prepares the reinforcement regions. In the case of unimpregnated material for preparing a reinforcement region, it can be sufficient to lay a second resin formulation layer on the reinforcement region or also to introduce a layer of the resin filler mixture in the form of a point or line, in order to provide sufficient resin formulation or resin filler mixture to the unimpregnated material for impregnation in the milling and impregnation line.

Reinforcement regions made of endless fibers can be unwound via a driven roller pair. Such a roller pair can also be moved in the x/y direction, preferably using a suitable linear drive, the endless fibers preferably being supplied in tubes. The endless fibers can also be oriented transversely to the production direction or angled thereto. The application device can also have a cutting device (cutting scissors) provided for targeted cutting to length. Fiber belts (also called fiber tapes) can be impregnated or unimpregnated. For the application, an unwinding station is provided as an application device, which is equivalent to that of the endless fibers. In certain circumstances, a longitudinal cutting device made of two cutting rollers arranged axially parallel to one another is provided, in order to decrease the width of the fiber belt. Fiber woven fabric, fiber laid fabric, or fiber nonwoven material are typically stamped or cut out of rolled products. They can then be supplied by means of an industrial robot or on a conveyor belt to the corresponding defined position on the resin formulation layer. The laying is performed via a gripper of the industrial robot, suitable transfer systems (grippers having x/y linear drive), or corresponding rolling belt systems. Overall, rolling belt systems have an advantage because they are suitable as an intermediate conveyor device of being used as a preliminary tray for a fiber laid fabric or woven fabric to be produced. This has the advantage that these can optionally be produced at a greater distance from the belt of the flat belt facility by means of separate devices and supplied in finished form in accordance with the requirements by means of the rolling belt system and can be laid directly or in a piece, respectively. The possibility thus results of also generating, producing, and laying complicated contours directly, for example, in a 3D-CAD environment.

The tailored mats are compressed in the further course of the method directly to form molded parts or laid fabrics are assembled from multiple tailored mats, which are finally compressed. Typically, the tailored mats are smaller than the tool geometry, so that a flowing procedure still results during the extrusion. The tailored mats are therefore preferably manufactured proportionally to the tool geometries. They are preferably laid appropriately oriented in the tool. Additional means for reinforcement are locally delimited, but can also be introduced in tracks longitudinally and/or transversely and/or as locally delimited conglomerations into the resin mat. The means for reinforcement are locally delimited in relation to the resin formulation layer, which means that the means for reinforcement are not applied over the entire surface. The difference to be clairified in the concept is that a typical quantity of reinforcement fibers is introduced during the production of SMC resin mats, this being carried out simultaneously over the width and above all over the entire surface. The additional means under discussion for reinforcement are to be considered as a further additional means, which are to assist the introduce “typical” fiber reinforcement locally and in delimited form, for reinforcement for this introduction of full-surface reinforcement.

Further advantageous measures and embodiments of the subject matter of the invention result from the subclaims and the following description with the drawing. The following illustrations are not to be considered directly as individual case solutions, but rather partially also contain general suggestions and problem solutions.

In the figures:

FIG. 1 shows an exemplary facility for the continuous production of fiber-reinforced resin mats in the course of the production of fiber-reinforced molded parts by means of extrusion in a molding press in a schematic side view having a production direction from left to right, the resin mats being produced between two endless belts,

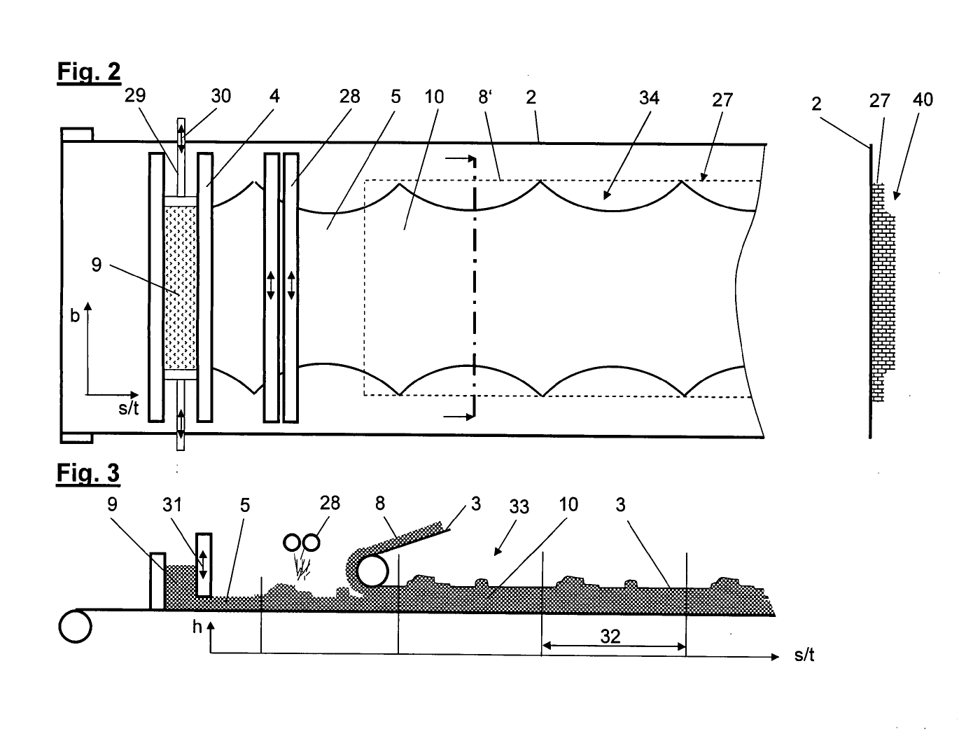

FIG. 2 shows a top view of the lower squeegeeing line and the lower (transport) belt with illustration of a possible contour of the resin mat in the width,

FIG. 3 shows a side view of the mixing device according to FIG. 1 having an illustration of a possible reoccurring resin mat contour at the height of the resin mat,

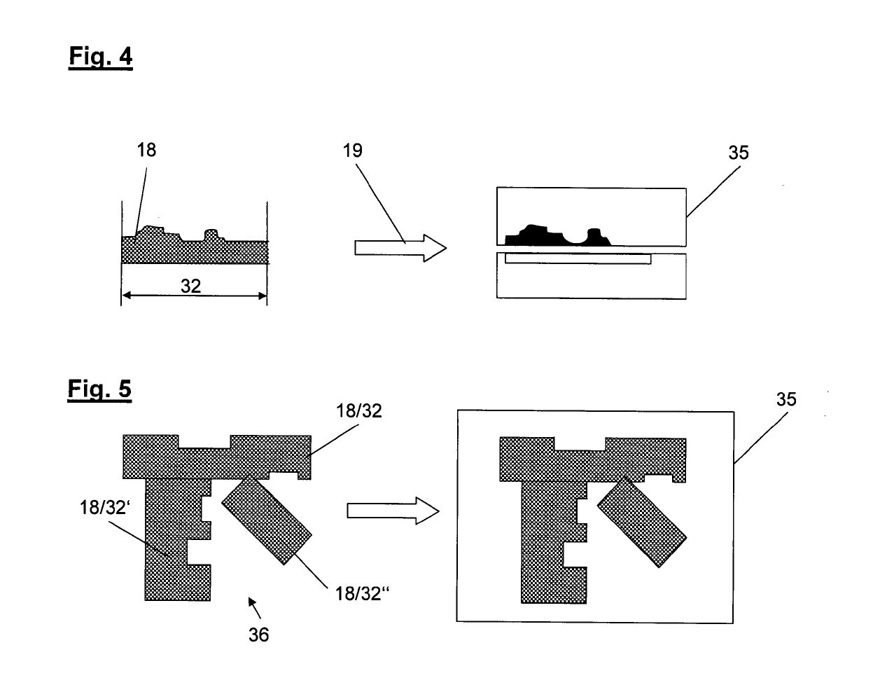

FIG. 4 shows a schematic side view of a resin mat contour as a tailored mat and an exemplary corresponding tool in a molding press,

FIG. 5 shows a schematic top view of a laid fabric made of multiple tailored mats of different contours for compression in a tool of a molding press,

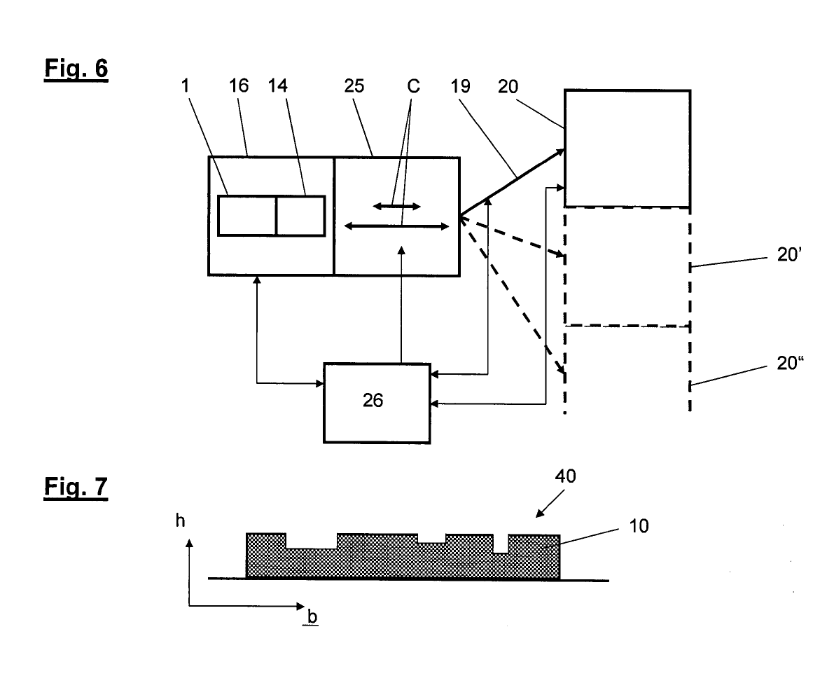

FIG. 6 shows a schematic view of a control and/or regulating device having a minimum-required number of linkages of the individual facility parts for carrying out the method in the case of the activation and supply of multiple molding presses using optimized tailored mats,

FIG. 7 shows an exemplary illustration of a differentiating contour over the width of a resin mat in section,

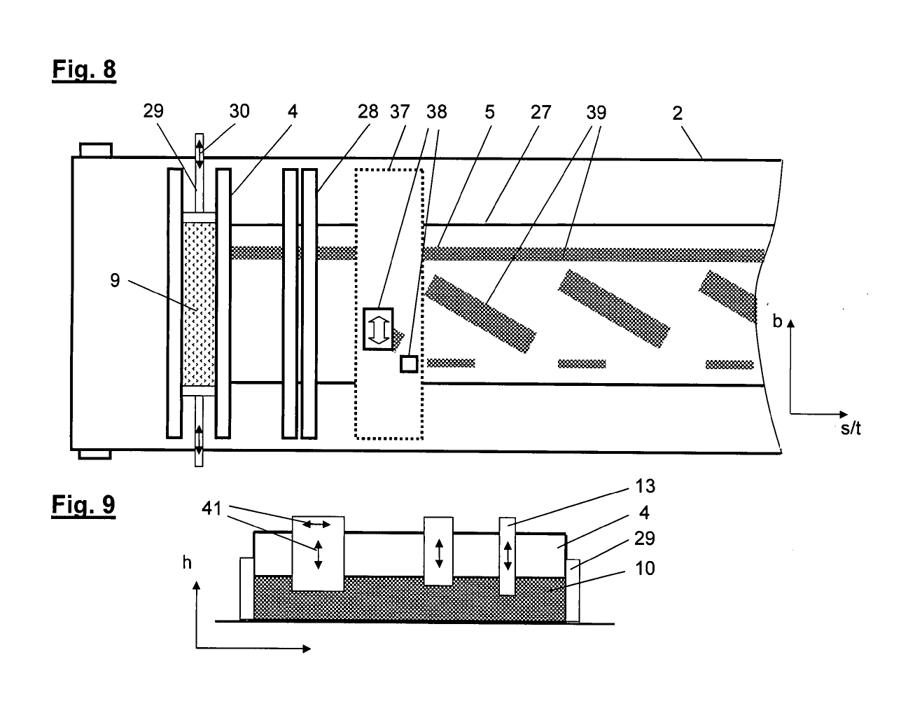

FIG. 8 shows an expansion of a possible facility by an application device for introducing reinforcement regions on a resin formulation layer of a resin mat to be produced,

FIG. 9 shows an illustration of possible positioning devices and optional associated squeegee blade slides to change the height of a resin formulation layer over the width during the preparation of a differentiating contour of a resin mat according to FIG. 7, and

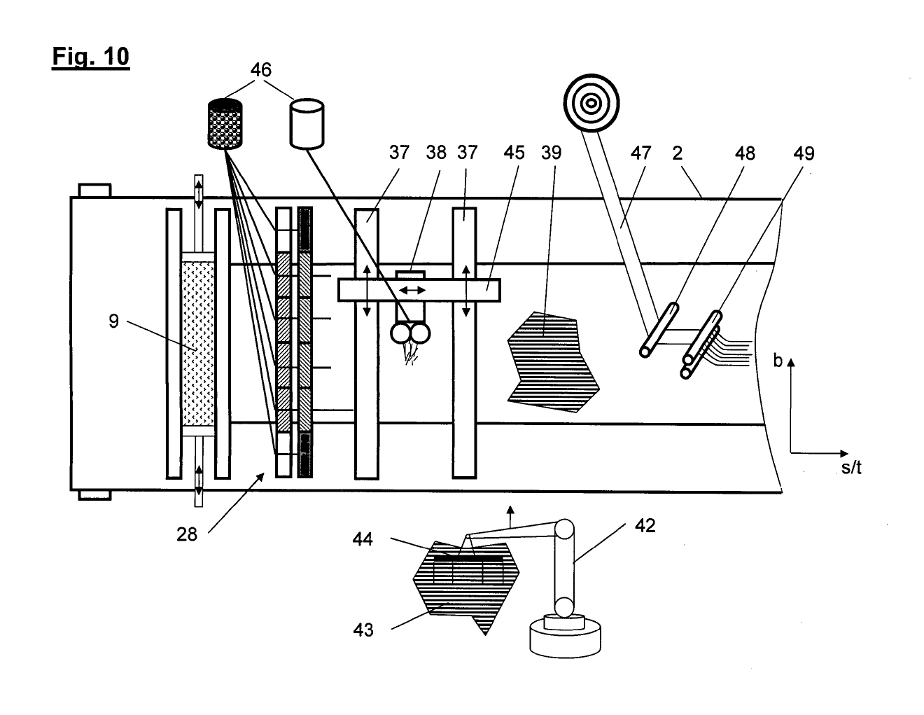

FIG. 10 shows a collection of exemplary application devices or reinforcement means to be applied to introduce reinforcement regions in a resin mat to be produced.

FIG. 1 shows a facility, which is suitable for carrying out the method but can also be operated independently, in a side view. For producing fiber-reinforced molded parts (SMC) by means of extrusion, it consists in its significant parts of a mixing device 1 having a resin formulation application line A, the milling and impregnation line B, and the thickening region C. A mixing station for mixing the individual components or a metering bin for the resin formulation 9 is not shown. The facility according to FIG. 1 shows a facility in which disposable films do not have to be used once in the mixing device 1, the milling and impregnation device 14, and in the thickening instantaneous heater 25 as the flat belt facility 16, but rather two reusable, endless belts 2 and 3 are used, which guide the resin mat 10 via deflection rollers 22 through these facility parts. A typically required ventilation line is not shown for reasons of clarity, but can also be a component of the flat belt facility 16. Specific resin formulations, in particular strongly adhesive resin formulations or resin formulations provided with chemical ingredients which attack the belts 2 and 3, can nonetheless require disposable films to be laid on the belts 2 and 3. The pre-mixed resin formulation 9 is squeegeed using the squeegee blade 4 onto the lower belt 2 to form the resin formulation layer 5. Fibers 6 made of cut glass are metered as long or short fibers, respectively, onto this lower resin formulation layer 5. Also, in particular for load-bearing parts or geometrical special features in the molded part, reinforcement regions can be generated by inlaying additional endless fibers, fiber mats, or further resin formulation layers in the required geometry. An application device 38 is arranged as desired for this purpose. The application device 38 preferably has at least one transverse crossbeam 37, on which the application device 38 can be moved by means of suitable linear conveyors in and transversely to the production direction or for height adjustment. It would also be conceivable, instead of the application device 38, to give an industrial robot (not shown) the task of the targeted and possibly reoccurring placement of reinforcement means to form reinforcement regions 38. Simultaneously, squeegeeing of the resin formulation layer 8 is performed by means of the squeegee blade 7 on the upper belt 3. After the joining of the two resin formulation layers 5 (having the fibers 6) and 8 and their introduction between the lower and upper rollers 11 and 13, the resin mat 10 is shaped in the milling and impregnation line B (milling and impregnation device 14), the fibers 6 being impregnated and milled together with the resin formulation 9. The endless resin mat 10 thus formed is then guided to the maturing by a thickening device 25. The heating device 24, preferably a microwave device, can be arranged in front of the thickening device 25 in the production direction. If the resin mat 10 has been matured, it is detached by cutter strips (not shown) from the belts 2 and 3 and supplied to the tailoring device 17, preferably associated with the transfer device 19. In the tailoring device 17, the resin mat 10 is cut as specified in length and/or in width and supplied by means of transfer means arranged in the transfer device 19, a transport belt here, as a tailored mat 18 to the molding press 20 and compressed and hardened in the molding press 20 to form the molded part 21.

FIG. 2 shows a top view of the lower squeegeeing line and the lower belt 2 with illustration of a possible contour 34 on the longitudinal side 27 of the resin mat 10 in the width b. To set the contour 34, the width b of the discharge of the squeegee blade 4 can be set by means of the laterally movable side walls 29, so that a wavy contour arises. The upper squeegee blade 7 was intentionally omitted in the illustration, to keep the drawing as simple and clear as possible. However, it is to be noted that, in addition to the possibility of adjusting, in a coordinated and/or accordingly simultaneous manner, both squeegee blades 4, 7 in their height b of the discharge in accordance with their spacing to one another or as a function of the point of incidence of the two resin formulation layers 5 and 8, the variant is also conceivable of only activating one squeegee blade 4 and 7 with respect to the width and/or height adjustment. This is illustrated in FIG. 2 by the dashed-line delimitation of the resin formulation layer 8′. Therefore, fundamentally not only the width b of the resin mat 10 would be changed by the blades 4 and 7 on the longitudinal sides 27 (contour 34 would be implemented as linear), but a change of the volume also results over the width b, i.e., transversely to the production direction. The change results in a differentiating contour 40 of the height h over the width b of the resin mat 10 between the belts 2 and 3, cf. the sectional image on the right side of FIG. 2 in this regard. The sectional image shows a longitudinal side 27 which is uniform over the width b, because the resin formulation layer 5 has been overlapped with another contour (in this case having a linear longitudinal side 27) of the resin formulation layer 8′. Therefore, smaller volumes or densities result in the edge regions on the longitudinal sides 27 of the resin mat 10. Preferably, however, such a variant would be carried out using three resin formulation layers and preferably the middle resin formulation layer would be implemented having a differentiating contour. Advantageously, the fiber component would be able to be scattered without problems over the entire width b, and a smaller proportion of resin formulation would be settable on the longitudinal sides without the required fibers, which are particularly important in thin regions of the molded part, being lost or only remaining on the surface (of a resin formulation layer). A person skilled in the art recognizes the manifold possibilities which the proposed setting possibilities offer and the manifold conceivable variations in this context.

Preferably, however, the width of the fiber introduction is adapted and/or the width adjustment is set on the opposite side in relation to the illustrated squeegee blades, so that the fibers always fall or are laid on a resin formulation layer. In the meaning of the invention, the width adjustment is thus also understood in the meaning of a volume change, so that the term contour can fundamentally also relate to the thickness, the density or volume change over the width and length of the resin mat 10 or the tailored mat 18, respectively. Furthermore, of course, it is conceivable that only one longitudinal side 27 of the resin mat 10 or the longitudinal sides in alternation are changed by the side walls 29. For saw-toothed or sharp-edged contour sections, it is conceivable to briefly stop the production speed of the flat belt facility 16 or to decrease the production speed until the appropriate positioning devices 30 have shifted the side walls 29 to their appropriate position. Flexible flat belt facilities 16 are capable of performing this, alternatively, a buffer system can be provided in the flat belt facility 16 for this purpose, which compensates for the stop in the resin formulation application line A and allows the milling and impregnation line B and/or the thickening line C to run further continuously.

The fiber supply device 28, preferably as a cut glass supply or as a cutting mechanism for endless fibers, is preferably also settable and variable over the width sectionally and/or in relation to the discharge quantity. A person skilled in the art clearly recognizes the advantages of this embodiment, fewer fibers 6 can now be scattered on especially in thin regions (cf. example of the contour according to FIG. 1 on the right) of the resin mat 10, in order to avoid “shining through” of the fibers 6 on the surface of a workpiece or molded part 21, respectively. It is also to be possible to achieve predefined mixing ratios between resin formulation quantity and fibers without problems. Of course, the fiber supply device 28 is to be activatable in accordance with the lateral adjustment to quasi-track the contour 34 and not scatter unnecessary fibers 6 on empty regions of the belt 2. The quantity of fibers 6 can also be adapted especially to difficult flowing regions of the tool. Fillers or reinforcement agents such as rovings, short cut or long fibers are conceivable as fibers, which are known in industrial application and are widespread and are suitable for fiber-reinforced material applications. Furthermore, hollow glass beads, fiber belts, fiber woven fabrics, oriented fibers, metal inlays, and fibers having a very long cutting length, which are preferably laid oriented on the resin formulation, are used. In particular, the latter list is used for local reinforcements.

FIG. 3 also shows a side view of the mixing device 1 according to FIG. 1 having an illustration of a possible reoccurring resin mat contour in the height h of a resin mat 10. In relation to the preceding figure, in this case the upper belt 3 is visible in parts. The schematic coordinate system represents the x axis in its longitudinal extension, as in the preceding figure, the progress over the time t, or the routes of the resin formulation 5, 8 or the resin mat 10, respectively. The exemplary contour mat 32 displays a reoccurring pattern of elevations in the contour 33, which can optionally correspond to a width adjustment according to FIG. 2. These elevations in the contour mat 32 are adapted to the contours of a tool 35 in a molding press 20. The positioning devices 31 move the squeegee blade 4 in height h and generate the contour 33 of the resin mat 10. As already described, the height adjustment of the squeegee blade 4 can optionally also be sectionally settable over width b, so that longitudinal strips of different heights result over the width, which can in turn have different heights h in relation to a contour mat 34 or to the entire resin mat 10.

It is clearly recognizable which possibilities are offered to a person skilled in the art in the present method and the facility if the contours 33 and 34 are settable in every possible conceivable variability and in particular are settable to the tools 35 in one or even multiple molding presses 20. In particular, with the aid of this solution, direct charging of complex tools 35 in molding presses 20 can be made possible and/or the preparation of laid fabrics made of tailored mat 18 for molding presses 20 can be significantly simplified, because decisive points for the extrusion in the tool 35 can already be set as optimized in width, height, and/or with respect to the fiber component in the resin mats 10 and do not have to be improved by tailoring or additional cut parts. In high-quality facilities, multilayer SMC semifinished products having more than two resin formulation layers can also be produced. Multiple fiber layers can also optionally be associated therewith. This applies not only for the contours 33, 34, but rather advantageously also for the quantity of fibers 6, which can be introduced optimized to the flow zones of the SMC semifinished product and are also helpful for preventing unimpregnated fiber agglomerations in a molded part 21.

FIG. 4 shows a schematic side view of a tailored mat 18, corresponding to a contour mat section 32 according to FIG. 3, which is introduced by the transfer device 19 into a tool 35 of a molding press 20 (not shown in the figure). The tailored mat 18, having its set contour, which is adapted in a simplified illustration to the corresponding tool 35, can be compressed to form a molded part 21.

FIG. 5 shows a schematic top view of a laid fabric 36 made of multiple tailored mats 18, which have different contours for the compression based on the contour mat sections 32, 32′, 32″ and are accordingly laid together by means of the transfer device 19 in a tool 35 of a molding press 20 and compressed therein. It is not necessarily provided that the contour mat sections 32, 32′, 32″ are produced in the same sequence. For example, it can be provided that a contour mat section 32^{X} is also produced between contour mat sections 32′ and 32″, which is used in a further molding press 20′ or in a further laid fabric 36 for a further molding press 20′, 20″.

FIG. 6 shows a very macroscopic and schematic illustration of a control and/or regulating device having a minimum-required linkage of the individual facility parts to execute a conceivable method for operating such a facility. At least one control device 26 is operationally linked with respect to control and/or regulation to at least one of the following facility parts: at least one molding press 20, 20′, 20″, . . . , a transfer device 19 and the flat belt facility 16 having a mixing device 1, a milling and impregnation device 15, a thickening device 25 as a production device for preparing an endless resin mat 10, which can be cut to length by means of a tailoring device 17 to form the tailored mat 18. With respect to control and/or regulation concepts, it is to be noted that the control devices preferably consist of a programmable universal computer, which alternately or simultaneously carries out the tasks of the control and regulation, in particular as a function of which facility part the control or regulation line is connected to, by special interfaces to the individual facility parts by suitable control technology and measuring pickups for feedback of actual values and for comparison to target values. To illustrate a control variable, for setting the thickening line C, it is only connected by a simple arrow to the thickening device 25, which does not preclude feedback about the status and corresponding regulations for precise setting of the thickening line C from being provided via sensors or being considered necessary. In the schematic illustration, one can also see the relationship of how the resin mats 10, which are produced in the mixing device 1 and the milling and impregnation device 14, are preferably transferred seamlessly into the thickening device 25 for the variable thickening line C, matured therein, and subsequently, after being cut to length, are transferred to the transfer device 19 for transport of the prepared tailored mats 18 into the corresponding molding press 20, 20′, 20″ . . . .

FIG. 7 shows an exemplary illustration of a differentiated contour 40 having different heights h over width b of a resin mat 10 in section. These variants would also be accordingly settable, but require some additional expenditure with respect to a settable squeegee blade 4, 7. In this regard, FIG. 9 shows exemplary additional squeegee blade slides 13, which are arranged on the squeegee blade 4, via which the basic height of the resin formulation is settable over the width, and sectionally hold back or release a discharge over the width. It is possible in particular to generate tracks of higher or lower material component on a resin formulation layer using this variant.

FIG. 8 shows an expansion of a possible facility by an application device for introducing reinforcement regions 39 onto a resin formulation layer 5 of a resin mat to be produced, the upper resin formulation layer 8 not being shown. By means of a suitable discharge device 38, which is preferably arranged on at least one transverse crossbeam over the belt 2 and is movable by means of at least one linear conveyor direction [sic; device], reinforcement regions 39 are formed in a resin mat 10 and are laid in a targeted manner so that they are arranged precisely fitted with the corresponding tool 35 of a molding press 20 in a contour mat section 32 and later in the corresponding tailored mat 18. Another reinforcement section is formed by a partial camber over the width by an elevated resin formulation application from the squeegee blade 4 and is represented as a continuous reinforcement region. A second application device 38 is arranged stationary and can discharge reinforcement regions, fibers and/or resin filler material, in strokes.

FIG. 10 shows a collection of exemplary discharge or, better, application devices 38 for reinforcement means to be applied to introduce reinforcement regions in a resin mat to be produced. In the production direction, a fiber supply device which is settable over the width is first located on the left side, which, because of a quite narrow width of the lower resin formulation layer 5, deactivates the two outer discharge regions and only lays endless fibers to be unwound from an endless fiber roll 46 either directly or chopped up on the resin formulation layer by means of the inner four discharge regions (shown shaded). Furthermore, a more sophisticated execution of a discharge device 38 on two transverse crossbeams having a linear conveyor device 45 is located in the production direction. A reinforcement region 39, formed from a fiber nonwoven material 43 or an equivalent conglomerate is already located on the resin formulation and is supplied from the outside by an industrial robot 42 and a gripper arranged thereon and is laid in accordance with the specifications on a defined location of a contour section. The fiber nonwoven material 43 can be stamped or cut out of an endless roll for this purpose, for example, and is preferably delivered on an intermediate conveyor device. The intermediate conveyor device can, for example, also be arranged between an illustrated application device 38 for a reinforcement region 39, so that the application device 38 can prepare, for example, a complicated contour on an intermediate conveyor device, preferably a transfer belt from an endless conveyor belt, which is then laid on the resin formulation layer simply by a movement of the transfer belt. Finally, as a further exemplary embodiment for a discharge device, a fiber belt guide roller 48, which withdraws a fiber belt 47 from a roller and supplies it to a longitudinal cutting device 49, is provided. In conjunction with a cutting-to-length device (cutting blade) (not shown), a local reinforcement region 39 can also be prepared therewith.

It may be stated that the illustration in the figure is only used for understanding and in parts is subject to deficiencies with respect to reality. It is comprehensible that a set contour in length, width, and height can certainly be “milled” by the milling and impregnation line B and accordingly no longer implements the sharpness of the original settings. In particular, the possibility of inducing jagged contour changes by a brief stop of the mixing device helps to mitigate this problem. Nonetheless, it is possible to implement and use the setting of the contours according to the invention. In particular, it is advantageous if the facility can be controlled via a universal computer, which takes over the tasks of a typical control and/or regulating device. In this device, the local meeting of the adjustable lower resin formulation layer 5 from the squeegee blade 4 with the application of the fibers 6 from the fiber supply device 28 and/or the application device 38 and using the upper resin formulation layer 8 from the squeegee blade 7 would be controlled accordingly. Simultaneously, distance-time tracking of the resulting resin mat is ensured, for example, via a time-dependent or distance-dependent or time-tracked controller, to ensure that the resin mat 10 is produced in such a manner that the produced contour mat sections 32 can be tailored without problems after the mixing device 1 to form the required tailored mats for one or more tools or laid fabrics and significant contours correspond to the requirements. For simplified distance/time tracking, before the two resin formulation layers are joined, a geometric special feature or another suitable marking can be arranged on at least one of the resin formulation layers, preferably in the outer region, in order to define the partition line of two contour mat sections in this manner and to place the partition cut by the tailoring device 17 exactly using a suitable recognition device. A suitable marking can be a barcode on a film or another suitable marking, for example, a film piece, which is automatically removed again by the tailoring device, or a color marking on the surface of the resin formulation. Color markings can be implemented using fluorescent agents, which are only recognizable under special lighting and preferably lose their fluorescence through a temperature increase in the tool of the molding press. It would also be conceivable to incorporate elevations or depressions during the production of the resin formulation layers, which can be identified by the recognition device and activate the tailoring device.

### LIST OF REFERENCE NUMERALS: P 1405

1 mixing device
2 lower belt
3 upper belt
4 lower squeegee blade
5 resin formulation layer
6 fibers
7 upper squeegee blade
8 resin formulation layer
9 resin formulation
10 resin mat
11 roller, lower
12 roller, upper
13 squeegee blade slide
14 milling and impregnation device
15 film draw-off
16 flat belt facility
17 tailoring device
18 tailored mat
19 transfer device
20 molding press
21 molded part
22 deflection roller
23 exit point
24 heating device
25 thickening device
26 control device
27 longitudinal side of 10
28 fiber supply device
29 movable side wall
30 positioning device of 29
31 positioning device of 4
32 contour mat section (endless)
33 contour of the height h longitudinally
34 contour of the width b
35 tool in 20
36 laid fabric
37 transverse crossbeam
38 application device
39 reinforcement regions
40 contour of the height h transversely
41 positioning device
42 industrial robot
43 fiber nonwoven material
44 gripper
45 linear conveyor device (b/s)
46 endless fiber roll
47 fiber belt
48 fiber belt guide roll
49 longitudinal cutting device
A resin formulation application line
B milling and impregnation line
C thickening line
b width of resin mat 10
h height of resin mat 10

1. A method for producing fiber-reinforced molded parts (SMC) by extrusion in a molding press from a fiber-reinforced resin mat, which is continuously produced in a flat belt facility, at least one resin formulation layer being joined with fibers in a mixing device, being mixed in a following milling and impregnation device, and finally being matured in a thickening device to form an endless resin mat, the endless resin mat being cut to form a tailored mat and subsequently being transferred directly or laid together to form a laid fabric with further tailored mats by a transfer device into a tool of a molding press and being compressed in the molding press to form a fiber-reinforced molded part, wherein to prepare a reinforcement region, which is delimited in length and/or width in relation to at least one resin formulation layer, before the joining of the resin formulation layers, means for reinforcement are applied to at least one resin formulation layer.

2. The method according to claim 1, wherein a resin formulation and/or at least one short fiber, one long fiber, cut glass, an endless fiber, an individual fiber, a fiber belt, (fiber tape), a fiber woven fabric, a fiber nonwoven material, and/or a joint conglomerate of these components are used as the means for reinforcement for the reinforcement region.

3. The method according to claim 1, wherein reinforcement regions form a topographic pattern in the resin mat, and this pattern, after the tailoring to form a tailored mat, substantially corresponds to the topography of a part of a laid fabric for a tool and/or to a tool itself.

4. The method according to claim 1, wherein the means for reinforcement or laid fabric of the reinforcement region are laid by an application device directly on the resin formulation layer and/or prefinished by an intermediate conveyor device on the resin formulation layer and/or are prepared directly during a squeegeeing of the resin formulation layer.

5. The method according to claim 1, wherein the reinforcement region is selected in its arrangement on a tailored mat to be cut out of the resin mat in such a manner that it corresponds to a corresponding geometry of the tool of the molding press or a part of a laid fabric for a tool.

6. The method according to claim 1, wherein contour mat sections are prepared from the resin formulation layers or from the endless resin mat, respectively, which substantially correspond in their length to the tailored mats for a tool or a part of a laid fabric and/or are at least proportionally adapted to the tool and/or the laid fabric and/or the molded part.

7. The method according to claim 1, wherein, to set at least one contour, a control device activates at least one positioning device for adjusting the width of a squeegee blade and/or the control device activates at least one positioning device for at least partially adjusting the height on a squeegee blade and/or the control device activates the fiber supply device to set the width and/or the quantity of fibers.

8. The method according to claim 1, wherein multiple successive contour mat sections of identical or different contours are assembled to form a laid fabric and are compressed in a tool of a molding press to form a molded part.

9. The method according to claim 1, wherein the means for reinforcement are at least partially impregnated with resin formulation and/or oriented before being laid on a resin formulation layer.

10. A facility for producing fiber-reinforced molded parts (SMC) by extrusion in a molding press from a fiber-reinforced resin mat, which is continuously produced in a flat belt facility, wherein a mixing device for joining at least one resin formulation layer with fibers, a following milling and impregnation device for mixing, and a thickening device for maturing the endless resin mat are arranged in the flat belt facility, a cutting mechanism being arranged to cut the endless resin mat to length to form a tailored mat, a transfer device being arranged to transfer the tailored mat to the molding press, and at least one molding press being arranged to compress the tailored mat to form a fiber-reinforced molded part, wherein, to prepare at least one reinforcement region at least one application device for laying means for reinforcement and/or at least one squeegee blade settable over the width for preparing means for reinforcement on a resin formulation layer is arranged in the production direction before the joining region of two resin formulation layers to form a resin mat.

11. The facility according to claim 10, wherein an application device is arranged for placing means for reinforcement for the reinforcement region, which is suitable for laying of a resin formulation layer and/or at least one short fiber, one long fiber, cut glass, an endless fiber, an individual fiber, a fiber belt (fiber tape), a fiber woven fabric, a fiber nonwoven material, and/or a conglomerate composed of these components.

12. The facility according to claim 10, wherein the application device for the means for reinforcement is arranged so it is movable on a transverse crossbeam over the width of a resin formulation layer by at least one linear conveyor device over the width and/or the production direction and/or in the spacing to the resin formulation layer.

13. The facility according to claim 10, wherein an industrial robot or a transfer device having a gripper and/or a transfer belt and/or at least one die for the resin formulation and/or a scattering device for fibers is arranged as the application device for the means for reinforcement.

14. The facility according to claim 10, wherein, to produce a variable contour to form a reinforcement region in height and/or width in an endless resin mat, at least one positioning device for setting different heights and/or at least one positioning device for setting different widths are arranged on at least one squeegee blade.

15. The facility according to claim 14, wherein measuring and/or positioning devices are arranged for distance and/or time tracking of the contours.

16. The facility according to claim 10, wherein a control device is operationally linked with respect to control and/or regulation to at least one of the following facility parts: at least one molding press, a transfer device, a flat belt facility to prepare an endless resin mat.

17. A resin mat for use in a molding press in the course of the production of molded parts, produced according to the method according to claim 1, wherein the resin mat, which is produced in a flat belt facility, has a differentiating contour and/or at least one reinforcement region consisting of means for reinforcement in its height and/or over its width.

18. The resin mat according to claim 17, wherein the resin mat is adapted in at least one contour and/or at least one reinforcement region to a tool or at least a part of a tool in a molding press.

19. A resin mat for use in a molding press in the course of the production of molded parts produced in a facility according to claim 10, wherein the resin mat, which is produced in a flat belt facility, has a differentiating contour and/or at least one reinforcement region consisting of means for reinforcement in its height and/or over its width.

20. The resin mat according to claim 19, wherein the resin mat is adapted in at least one contour and/or at least one reinforcement region to a tool or at least a part of a tool in a molding press.
